(19) United States
(12) Patent Application Publication
(10) Pub. No.: US 2005/0271375 A1
(43) Pub. Date: Dec. 8, 2005

(54) Imaging apparatus

(75) Inventors: Tsuyoshi Watanabe, Minamitsuru-gun (JP); Kozo Watanabe, Minamitsuru-gun (JP); Jo Kinoshita, Fujiyoshida-shi (JP)

Correspondence Address: BROWDY AND NEIMARK, P.L.L.C.;624 NINTH STREET, NW, SUITE 300, WASHINGTON, DC, 20001-5303, US

(73) Assignee: Citizen Electronics Co. Ltd., Fujiyoshida-shi (JP)

(21) Appl. No.: 11/131,328

(22) Filed: May 18, 2005

(30) Foreign Application Priority Data
May 18, 2004 (JP) P2004-147108
Feb. 17, 2005 (JP) P2005-41408

(51) Int. Cl. G03B 3/00

(52) U.S. Cl. 396/144

(57) ABSTRACT

An imaging apparatus, comprising a holder having a solid-state image sensor, a lens barrel rotatably engaged with the holder and having an optical device for focusing an image on the solid-state image sensor's acceptance surface, and a focus-adjusting device provided between the lens barrel and the holder, the focus-adjusting device including a cam mechanism capable of changing a distance between the optical device and the solid-state image sensor in response to relative rotation between the holder and the lens barrel, the cam mechanism including plural pairs of controlling parts having a plurality of bearing surfaces disposed on one of the lens barrel and the holder to space out peripherally and projecting in an optical direction of the optical device, and a plurality of receiving surfaces disposed peripherally on the other of the lens barrel and the holder to be positioned at equal intervals, projecting in the optical direction of the optical device and contactable with each of the bearing surfaces.

### CROSS-REFERENCE TO THE RELATED APPLICATIONS

The application claims the priority benefit of Japanese Patent Applications No. 2004-147108 filed on May 18, 2004 and No. 2005-041408 filed on Feb. 17, 2005, the entire descriptions of which are incorporated herein by reference.

### BACKGROUND OF THE INVENTION

1. Field of the Invention

The present invention relates to a solid-state image sensor, and an imaging apparatus including the solid-state image sensor and an optical device, capable of adjusting a distance between the solid-state image sensor and the optical device, accurately, securely and with easy operations to focus an image on the solid-state image sensor's acceptance surface.

2. Description of Related Art

Each of imaging apparatuses assembled in digital cameras, notebook computers with cameras, mobile phones or the like is structured from parts such as a solid-state image sensor, a circuit board, and an optical device including lenses.

Recently, a miniaturized imaging apparatus including a solid-state image sensor and an optical device is used for a camera-equipped cell-phone, and in that case, if the pixel count of the sensor increases, setting the sensor and the optical device in accurate positions is required more than ever to focus an image on the sensor's acceptance surface. For example, if the sensor has a pixel count of one hundred thousand, an image may appear to be focused, even if the optical device's focal position deviates about 50 μm. However, if the sensor has a pixel count of three hundred thousands, an image may not appear to be focused, even if the optical device's focal position just deviates about 20 μm. For a camera-equipped cell-phone, more and more increased pixel count is required.

Therefore, to make securely a positional relation between the optical device and the solid-state image sensor accurately, in particular a distance therebetween, there has been proposed a structure in which a mounted position of an integrated circuit, which corresponds to the solid-state image sensor is variable (for reference, see JP2001-333332A, pages 2, and 3, FIG. 1). In the conventional imaging apparatus, resilient protrusions are provided on a lens barrel so as to contact with bumps provided on the integrated circuit, a position of the integrated circuit in a direction of optical axis is adjusted by resilient deformation of the protrusions generated by applying a pressure to the integrated circuit when the integrated circuit is mounted on the lens barrel.

In addition, FIG. 11 illustrates an example of another conventional imaging apparatus.

In FIG. 11, 100 shows a first lens, 101 a second lens, and 102 an integrated circuit (IC) which corresponds to a solid-state image sensor. 103 shows a spacer disposed between the first lens 100 and the second lens 101. The parts as described above are fixed to a case (not shown) in the imaging apparatus. By selecting and using the some spacers 103 having different thickness, a position between a surface of the integrated circuit 102 and a surface of the second lens 101 is adjusted in the optical axis direction.

However, in the conventional imaging apparatus disclosed in JP2001-333332A, because the adjustment of the integrated circuit in the direction of optical axis is executed by the resilient deformation of the protrusions generated by applying the pressure to the integrated circuit, there is a problem that a range of adjustment is narrower and the integrated circuit tends to deform by the applied pressure.

On the other hand, in the conventional imaging apparatus as shown in FIG. 11, because usual thicknesses of used spacers 103 are 25, 38 and 50 μm, actually it is difficult to make a spacer having a thickness of 10 μm or less, the adjustment of height of 10 μm or less cannot be carried out. Moreover, the second lens must be removed from a lens barrel (not shown) every the interchange of the spacer 103 inserted between the first lens 100 and the second lens 101, therefore there is a problem that some processes are required for the interchange, the completed imaging apparatus is expensive.

### SUMMARY OF THE INVENTION

An object of the present invention is to provide an imaging apparatus capable of adjusting a focal length accurately and easily, and also accomplishing improved productivity and cost down.

According to one embodiment of the present invention, the imaging apparatus comprises a holder having a solid-state image sensor, a lens barrel having an optical device and attached rotatably to the holder for focusing an image on the solid-state image sensor's acceptance surface, and a focus-adjusting device provided between the lens barrel and the holder.

The focus-adjusting device includes a cam mechanism capable of changing an interval between the optical device and the solid-state image sensor in response to relative rotation of controlling parts provided between the holder and the lens barrel.

The cam mechanism includes plural pairs of controlling parts having a plurality of bearing surfaces disposed on either of the lens barrel or the holder and a plurality of receiving surfaces disposed on the other of the lens barrel or the holder.

The controlling parts comprise a combination of engagement between the respective bearing surface and the respective receiving surface.

The plural pairs of controlling parts are set to have different projected heights with respect to each other in the direction of the optical axis.

### BRIEF DESCRIPTION OF THE DRAWINGS

FIG. 1 is a central longitudinal sectional view showing one embodiment of an imaging apparatus according to the present invention.

FIG. 2 is a plan view showing a lens barrel having one embodiment of a cam mechanism in the imaging apparatus shown in FIG. 1.

FIG. 3 is a plan view of a holder used in the imaging apparatus shown in FIG. 1.

FIG. 4 is a partial perspective view of the holder shown in FIG. 3.

FIG. 5 is a perspective view showing a lens barrel having another embodiment of the cam mechanism in the imaging apparatus according to the present invention.

FIG. 6 is a perspective view of a holder attached to the lens barrel shown in FIG. 5.

FIG. 7 is a perspective view showing a lens barrel having still another embodiment of the cam mechanism in the imaging apparatus according to the present invention.

FIG. 8 is a partial elevational view showing a portion of the cam mechanism in the lens barrel shown in FIG. 7.

FIG. 9 is a perspective view showing a lens barrel having further another embodiment of the cam mechanism in the imaging apparatus according to the present invention.

FIG. 10 is a perspective view of the holder having the cam mechanism shown in FIG. 9.

FIG. 11 is a schematic sectional view of a conventional imaging apparatus.

### DETAILED DESCRIPTION OF THE PREFERRED EMBODIMENTS

Preferred embodiments of the present invention will be explained with reference to the accompanying drawings below.

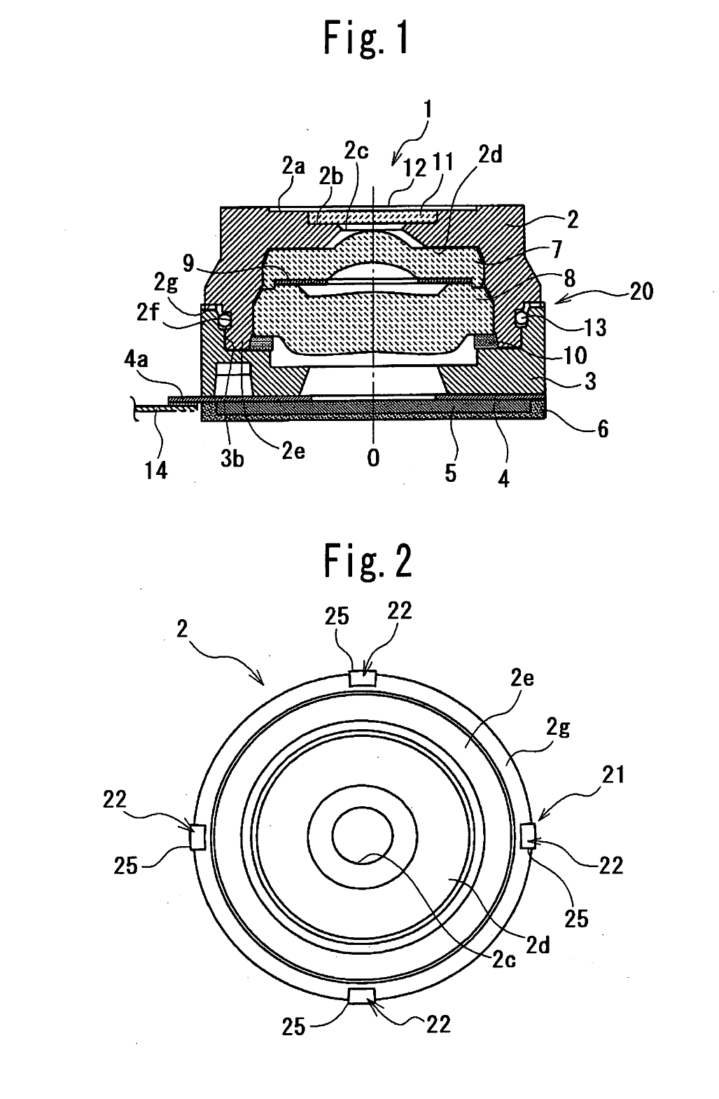

Referring to FIG. 1, one embodiment of an imaging apparatus according to the present invention is shown. The imaging apparatus 1 includes a generally cylindrical lens barrel 2 in which an optical device including lenses and so on, as described hereinafter is fixed, and a generally cubic holder 3 constituting a case for the imaging apparatus 1 by combining with the lens barrel 2. A flexible printed circuit board (FPC ) 4 is attached to a lower end surface of the holder 3. The FPC 4 has a connecting portion 4a, which extends over a side surface of the holder 3 to connect with an exterior electric circuit (not shown).

A solid-state image sensor 5 which is an integrated circuit (IC) is attached to the holder 3. The solid-state image sensor 5 is mounted on the FPC 4 in a manner of facedown, for example.

Meanwhile, a circumference of the solid-state image sensor 5 is sealed by a sealing resin 6, except for an acceptance surface for receiving light.

The lens barrel 2 has counter sunk portions 2a and 2b formed at an upper and central part of the lens barrel 2, for example, and a light receiving opening 2c provided at a central portion of the counter sunk portions. The lens barrel 2 also has a step 2d formed below the opening 2c, and a groove 2f and a step 2g formed on an outer circumference of a lower cylindrical portion 2e.

The optical device including a first lens 7 housed in the lens barrel 2 to contact with the step 2d and a second lens 8 placed on the first lens 7 acts to focus an image on the acceptance surface of the solid-state image sensor 5. A light-shielding spacer 9 is disposed between the first lens 7 and the second lens 8. Here, reference number 10 shows a ring-shaped lens holding member, which is fixed to the lens barrel 2 to hold a lower surface of the second lens 8. 11 shows a filter fixed on the counter sunk portion 2b to shield infrared ray, and 12 shows a transparent decorative seal fixed on the counter sunk portion 2a. 13 shows a light-shielding O-ring disposed between a cylindrical wall surface 3a of the holder 3 and the groove 2f. 14 shows an FPC, which is an interface for connecting the imaging apparatus 1 with an exterior device and connected with the connecting portion 4a of the FPC 4 by a connector such as an ACF (anisotropic conductive film). In addition, O in FIG. 1 shows a common optical axis of the optical device and the solid-state image sensor 5.

A focus-adjusting device 20 is provided between the lens barrel 2 and the holder 3. The focus-adjusting device 20 includes a cam mechanism 21 capable of changing a distance between the optical device and the solid-state image sensor 5 in response to the relative rotation of the lens barrel 2 and the holder 3.

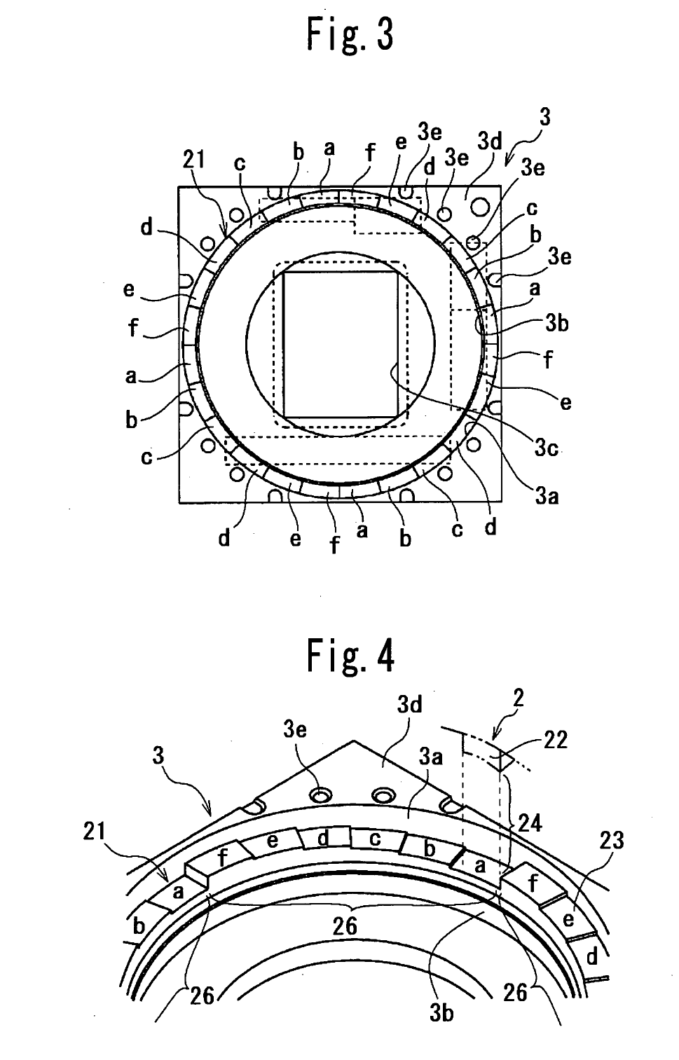

FIGS. 2 to 4 illustrate one embodiment of the cam mechanism 21. The cam mechanism 21 in this embodiment includes plural pairs of controlling parts 24 having a plurality of bearing surfaces 22 peripherally disposed on the lens barrel 2 to be positioned at equal intervals and projecting in a direction of the optical axis O of the optical device, as shown in FIG. 2, and a plurality of receiving surfaces 23 disposed on the holder 3 to space out peripherally, projecting in the direction of optical axis and each of which is contactable with each of the bearing surfaces 22, as shown in FIGS. 3 and 4. Each of the plural pairs of controlling parts comprises a combination of the respective bearing surface 22 and the respective receiving surface 23.

More specifically, the bearing surfaces 22 in FIG. 2, for example, are composed by four protrusions 25 disposed to be positioned at equal intervals on the barrel's circumferential step 2g contacting with the holder 3. The four protrusions 25 here project in the direction of optical axis O shown in FIG. 1. Also, in this embodiment, the protrusions 25 have equally projected heights or lengths, as shown in FIGS. 1 and 2.

The receiving surfaces 23 in FIG. 4 comprise four sets of stepped units 26 (a to f) disposed to be positioned in order of a to f here in the holder's cylindrical portion 3a. The stepped units (a to f) 26 contact with the bearing surfaces 22 on the barrel's circumferential step 2g. Each of the stepped units 26 here has six steps a through f, for example. Here, the steps a, b, c, d, e and f are set so that the projected height of the step gradually increases from minimum (a) to maximum (f) in order.

The plural pairs of controlling parts 24 are formed by combining each of the four sets of stepped units 26 and one of the four bearing surfaces 22. For example, when one of the bearing surfaces 22 faces and contacts with the step a, other bearing surfaces contact with the corresponding steps a of other stepped units. When allowing the bearing surfaces 22 to face any steps, the lens barrel 2 and the holder 3 are rotated in engagement. From this state, if the bearing surfaces 22 contact with the steps f, an interval between the optical device and the solid-state image sensor's acceptance surface in the direction of optical axis becomes more distant than when the bearing surfaces contact with the corresponding steps a.

In this way, the interval between the optical device and the solid-state image sensor's acceptance surface can be changed on the basis of the projected heights of the steps by contacting the bearing surfaces 22 with any of the steps a through f.

Meanwhile, although the bearing surfaces 22 are provided on the lens barrel 2 and the receiving surfaces 23 are provided on the holder 3, the bearing surfaces 22 may be provided on the holder 3, and the receiving surfaces 23 may be provided on the lens barrel 2, because the cam mechanism effect will be achieved in either case.

Additionally, the holder 3 here is provided with an inner peripheral wall 3b inside the receiving surfaces 23 so that an outer periphery of the cylindrical portion 2e of the lens barrel 2 is fitted in the inner peripheral wall 3b. A light receiving opening 3c is formed in a central portion of the holder 3.

Next, the focusing of the imaging apparatus 1 is explained.

The optical device is first assembled in and fixed to the lens barrel 2, and the solid-state image sensor 5 is contained in and mounted on the holder 3. The lens barrel 2 in which the optical device is assembled, and the holder 3 in which the solid-state image sensor 5 is assembled are then combined. At this time, the lens barrel 2 and the holder 3 are rotated in engagement so as to contact one of the bearing surfaces 22 in the lens barrel 2 with any one of the steps a, b, c, d, e, and f in the holder 3, for example, the step c or d.

The alignment in a circumferential direction of the bearing surfaces 22 and the receiving surfaces 23 can be carried out based on a concave portion 3e as a mark for aligning provided on an upper end surface 3d outside the receiving surfaces. In this state, because light emitted from a chart surface of a test chart disposed in front of the lens barrel 2 previously is adapted to focus an image on an acceptance surface of the solid-state image sensor 5 through the filter 11, the first lens 7 and the second lens 8, sharpness of the image is confirmed by a monitor screen connected with the FPC 14, which is the interface drawn out from the FPC 4.

A desired value on design is set so that of the step-shaped receiving surfaces 23, that is to say, the steps a through f, the height of the step in the vicinity of the center, for example, the step c or d corresponds to an appropriate distance between the optical device and the solid-state image sensor 5. If the focusing is not obtained with the step, the focal length of the optical device can be adjusted by selecting the adjacent other step and resetting the lens barrel 2 and the holder 3. If the appropriate focal length is determined, staying that state, the lens barrel 2 and the holder 3 are fixed by applying an adhesive therebetween, for example.

As described above, because the plurality of receiving surfaces 23 contacting with the bearing surfaces 22 in the lens barrel 2 and having different heights are provided on the holder 3, the adjustment of focusing between the lens barrel 2 having the optical device and the holder 3 having the solid-state image sensor 5 can be achieved easily by combining the bearing surface and the receiving surfaces, therefore cost down of the imaging apparatus can be accomplished.

In the forgoing, the two lenses 7 and 8 are used, but the lenses are not limited necessarily to two. Moreover, the four bearing surfaces 22 are provided on the lens barrel 2, but three or any number of bearing surfaces may be used. In addition, the aligning mark for the rotational position of the lens barrel and the holder as described above may be provided on either one of the bearing surfaces and the receiving surfaces or both.

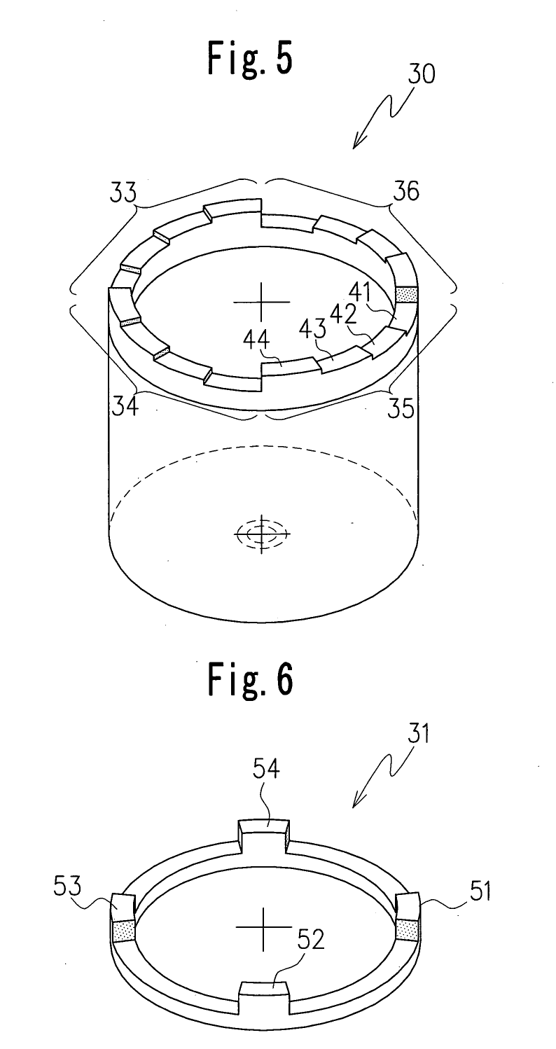

FIGS. 5 and 6 illustrate another embodiment of the imaging apparatus according to the present invention.

The imaging apparatus in this embodiment includes a generally cylindrical lens barrel 30 containing an optical device (not shown) and a holder 31 attached to the lens barrel 2 and holding a solid-state image sensor (not shown). In this embodiment, the positional relation of the optical device and the solid-state image sensor 5 can be adjusted when fitting the lens barrel 30 and the holder 31.

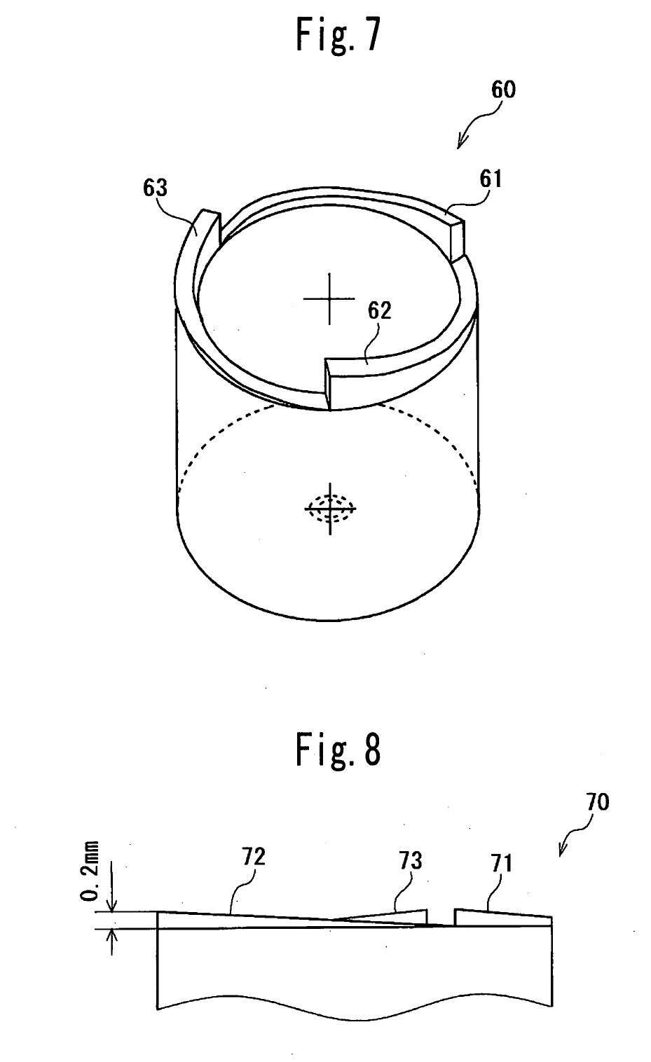

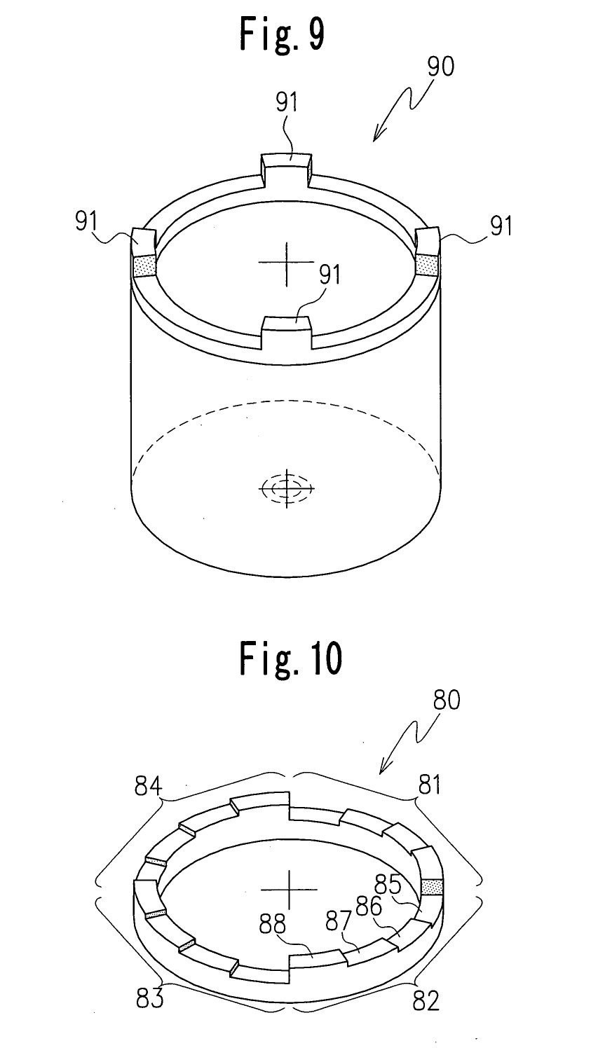

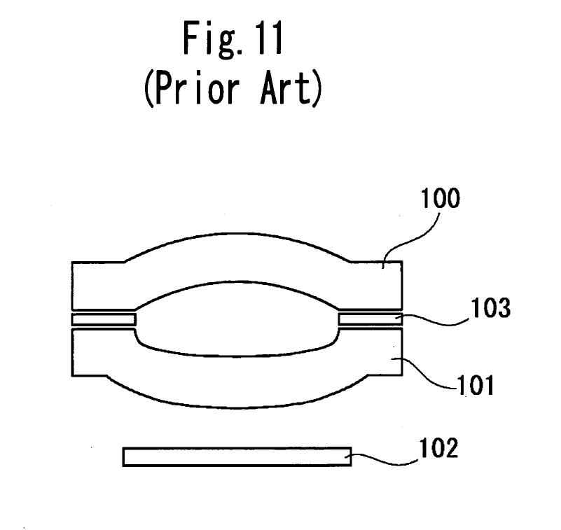

Meanwhile, for convenience on the description, the lens barrel 30 is shown in an inverted manner of the lens barrel shown in FIG. 1. The manner is also applied in an embodiment shown in FIGS. 7 and 9.

The imaging apparatus in this embodiment includes a plurality of stepwise receiving surfaces having a minute difference in level (for example, 10 μm) therebetween, formed on a fitting surface of the lens barrel 30 to the holder 31 along a cylindrical wall surface which forms the fitting surface, as shown in FIG. 5. In other words, four stepped units 33, 34, 35, and 36 are disposed with a space of 90° from each other. Each of the stepped units has four steps 41 to 44 which have different heights. Four bearing surfaces 51, 52, 53 and 54 are disposed to circumferentially space out on the holder 31, and the four bearing surfaces 51 through 54, in other words, the projected lengths in the direction of optical axis have equal heights.

When fitting the lens barrel 30 and the holder 31, one of the bearing surfaces 51, 52, 53 and 54 can be contacted with any of the stepped units. This embodiment has the same operation and effects as the previous embodiment except for that the bearing surfaces 51 through 54 are provided on the holder 31, the stepped units 33 through 36 which are the receiving surfaces are provided on the lens barrel 30, and the number of the receiving surfaces is small.

Meanwhile, it is a design matter determined in view of requested specifications, manufacturing ability or the like how many of the bearing and receiving surfaces are provided, how many of the stepwise receiving surfaces are provided, how stepped sizes of the stepwise receiving surfaces are set, or the like.

In this embodiment, because the receiving surfaces, in other words, the stepped units 33 through 36 are provided on the lens barrel 30, the following advantageous effects are obtained.

It is suitable that the lens barrel 30 is produced individually because a relatively higher accuracy is requested for the lens barrel to fix the optical device and so on, and a relatively higher accuracy is also requested for the receiving surfaces. Because the lens barrel is individually produced, the increment of accuracy of the product can be accomplished.

On the other hand, in the holder 31, because accuracy is not requested for attachment of the solid-state image sensor 5 and the bearing surfaces and the holder is easy to correct, several tens of holders can be produced collectively, thereby yield thereof is boosted and an inexpensive imaging apparatus can be accomplished.

FIGS. 7 and 8 illustrate still another embodiment of the imaging apparatus according to the present invention.

In this embodiment, as shown in FIG. 7, a plurality of inclined receiving surfaces 61, 62 and 63 are provided on a cylindrical lens barrel 60. In this embodiment, the receiving surfaces 61, 62 and 63 comprise three inclined surfaces disposed with a space of 120° from each other, for example, not the stepwise receiving surfaces as shown in the above-mentioned embodiments. Three bearing surfaces 71, 72 and 73 having the similar structure to the receiving surfaces 61, 62 and 63 are formed on a holder 70 attached to the lens barrel 60, as shown in FIG. 8. The maximum height of the receiving surfaces and bearing surfaces is about 0.2 mm, as shown in FIG. 8, the heights of the receiving surfaces and bearing surfaces are inclined gradually and smoothly from 0.2 mm to zero (0). In addition, in this embodiment, the bearing surfaces may be formed into a plurality of projected portions having an equal height, similarly to the above-mentioned embodiments.

When fitting the lens barrel 60 and holder 70, any of the receiving surfaces 61, 62 and 63 disposed at three places and any of the bearing surfaces 71, 72 and 73 of the holder 70 are contacted. At this time, when each bearing surface is contacted with the vicinity of a central portion of each receiving surface, the optical device and the solid-state image sensor are set previously so that an appropriate distance is provided between the optical device and the solid-state image sensor's acceptance surface. If the focusing is not obtained at the vicinity of the central portion of the receiving surface, the lens barrel 60 and the holder 70 are rotated to allow the positional relation of the optical device and the solid-state image sensor or the focal length to adjust. At this time, because the adjustment of the focusing can be executed continuously in this embodiment, the adjustment easier than the above-mentioned two embodiments can be accomplished.

FIGS. 9 and 10 illustrate further another embodiment of the imaging apparatus according to the present invention.

In this embodiment, a plurality of stepped units 81, 82, 83 and 84 are disposed on a fitting surface of a holder 80 to a lens barrel 90 along a cylindrical wall which forms the fitting surface, a plurality of bearing surfaces 91 are formed on the lens barrel 90 attached to the holder 80. Each of the stepped units has, for example, four stepwise receiving surfaces 85, 86, 87 and 88 having a minute difference in level (for example, 10 μm) therebetween.

The bearing surfaces 91 are provided at four places, the heights of the four bearing surfaces 91 in the direction of optical axis are set equally.

In fitting the lens barrel 90 and the holder 80, any of the receiving surfaces and any of the bearing surfaces are contacted. An operation and effects in this embodiment are the same as the above-mentioned embodiments.

In this embodiment, because variations of the lenses and so on, and characteristics of the finished parts including a fine displacement or the like of the solid-state image sensor can be compensated without an excess high accuracy being requested for the lens barrel on which the optical device is mounted, and the holder to which the solid-state image sensor is fixed, a significant increment of the yield and reduction of a time for assembling the imaging apparatus can be accomplished.

As described above, according to the present invention, the adjustment for the focusing of the optical device can be executed easily and securely.

Moreover, because parts to which a relatively high accuracy is requested are collected to the lens barrel, the lens barrel having a high accuracy can be made as a single molded article.

Also, because parts to which a high accuracy is requested are removed from the holder, efficient yield can be accomplished and mass production can be executed inexpensively.

Furthermore, because the receiving surfaces in the focus-adjusting device are formed into the inclined surfaces, the positional adjustment of the optical device and the solid-state image sensor is easier.

Meanwhile, of the contacting surfaces of the lens barrel and the holder which are fitted in the specification, the surfaces of the lens barrel are referred to as the receiving surfaces, and the surfaces of the holder are referred to as the bearing surfaces, but if the surfaces the surfaces of the lens barrel are referred to as the bearing surfaces, and the surfaces of the holder are referred to as the receiving surfaces, the same operation and effects can be obtained. In other words, in the specification as described above, even if the receiving surfaces are substituted for the bearing surfaces and the bearing surfaces are substituted for the receiving surfaces, the technical content is substantially the same.

Although the preferred embodiments of the present invention have been described, the present invention is not limited to the embodiments, various changes and modifications can be made to the embodiments.

1. An imaging apparatus, comprising:
a holder including a solid-state image sensor having an acceptance surface;
a lens barrel having an optical device and to be rotatably engaged with the holder to focus an image on the acceptance surface of the solid-state image sensor; and
a focus-adjusting device provided between the lens barrel and the holder,
the focus-adjusting device including a cam mechanism capable of changing a distance between the optical device and the solid-state image sensor in response to relative rotation of the holder and the lens barrel.

2. The imaging apparatus according to claim 1,
wherein the cam mechanism includes plural pairs of controlling parts including a plurality of bearing surfaces disposed on either of the lens barrel or the holder to be positioned at equal intervals and projecting in a direction of an optical axis of the optical device, and a plurality of receiving surfaces disposed on the other of the lens barrel or the holder and provided in the optical axis direction of the optical device and contactable with each of the bearing surfaces,
the controlling parts comprise a series of combination of the respective bearing surface and the respective receiving surface, and
an engaged distance in the optical axis direction of each combination is set to be different from that of the other pairs of controlling parts.

3. The imaging apparatus according to claim 2,
wherein the lens barrel has a generally cylindrical shape,
the holder has a generally cylindrical shape to be rotatably engaged with the lens barrel,
the bearing surfaces positioned at equal intervals are disposed on either the lens barrel's end surface or the holder's end surface, and
the receiving surfaces are disposed on the other of the lens barrel's end surface or the holder's end surface.

4. The imaging apparatus according to claim 2,
wherein the plurality of receiving surfaces extend from the end surface of either the lens barrel or the holder so that the distances of the receiving surfaces in the optical axis direction are different with respect to one another, and
the plurality of the bearing surfaces extend from the end surface of the other, the lens barrel or the holder, so that the heights of the bearing surfaces in the optical axis direction are same with respect to one another.

5. The imaging apparatus according to claim 2,
wherein each of the plural pairs of controlling parts comprises a combination of at least two receiving surfaces and at least two bearing surfaces contactable with the receiving surfaces,
the two receiving surfaces are different from the other receiving surfaces in height, and
the bearing surfaces have the same height.

6. The imaging apparatus according to claim 2,
wherein the receiving surfaces are provided on the holder, and
the bearing surfaces are provided on the lens barrel.

7. The imaging apparatus according to claim 2,
wherein the receiving surfaces are provided on the lens barrel, and
the bearing surfaces are provided on the holder.

8. The imaging apparatus according to claim 2,
wherein the cam mechanism includes a plurality of bearing surfaces having the same height in the optical axis direction of the optical device and step-like receiving surfaces having minute differences in level, contactable with the bearing surfaces.

9. The imaging apparatus according to claim 2,
wherein the cam mechanism includes a plurality of bearing surfaces having the same height in the optical axis direction of the optical device and inclined receiving surfaces contactable with the bearing surfaces.
